(19) United States
(12) Patent Application Publication
(10) Pub. No.: US 2012/0318371 A1
(43) Pub. Date: Dec. 20, 2012

(54) Bellows assembly and engaging structure

(75) Inventors: C. Joseph Rynders, JR., Peoria, IL (US); Arthur Scott Lindell, Morton, IL (US); Vikas Sheth, Edwards, IL (US); Bradley L. Fix, Peoria, IL (US); Kipp D. Edwards, Victoria, TX (US); Steven F. Meister, Chillicothe, IL (US); Gabriel Stefan, Peterborough (GB); Srikanth Tummala, Peterborough (GB)

(73) Assignee: CATERPILLAR INC., Peoria, IL (US)

(21) Appl. No.: 13/163,423

(22) Filed: Jun. 17, 2011

(51) Int. Cl. B23P 19/00; F16L 3/00

(52) U.S. Cl. 137/15.01; 137/343

(57) ABSTRACT

A gas handling transport assembly includes a bellows assembly together with a bellows engaging structure. The bellows engaging structure includes an engaging surface that engages an outer surface of the bellows assembly to restrain movement thereof. An open first end and an open second end may be provided along a longitudinal axis of the bellows assembly. A method of using the assembly is also provided.

### TECHNICAL FIELD

This disclosure relates generally to gas handling systems and, more particularly to, a bellows assembly with a structure for limiting movement of the bellows assembly during transportation and installation.

### BACKGROUND

Systems for transporting gases take various forms and often use a bellows assembly to absorb thermal movement and vibrations in duct or piping systems. The bellows assembly typically includes a series of convolutions or undulations positioned between a pair of flanges or end members. This arrangement allows the end members to move relative to each other and compensate for thermal expansion and contraction of the gas handling system in which the bellows assembly is installed. In addition, the bellows assembly also provides a vibration dampening function and permits axial, lateral and rotational movement between the two flanges.

U.S. Patent Publication No. US 2010/0154397 A1 discloses an exhaust gas system for use with an internal combustion engine. The exhaust gas system includes a pair of ball joints and a slip-joint together with a bellows assembly. These components provide significant flexibility in adjusting the position of the ends of the exhaust gas system as well as the path of the exhaust gas systems between the two ends.

The foregoing background discussion is intended solely to aid the reader. It is not intended to limit the innovations described herein nor to limit or expand the prior art discussed. Thus, the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY

In one aspect, a gas handling transport assembly includes a flexible bellows assembly, a bellows engaging structure and a securing device. The bellows assembly has an outer surface with a first end, a second end and a longitudinal axis. A plurality of convolutions are positioned between the first end and the second end and along the longitudinal axis. The bellows engaging structure has an open first end and an open second end along the longitudinal axis of the bellows assembly. An engaging surface of the bellows engaging structure is configured to engage a portion of the outer surface of the bellows assembly. The securing device removably secures the bellows engaging structure to the bellows assembly.

In another aspect, a method of assembling a gas handling transport system may include providing a first section having a flexible bellows assembly with a bellows engaging structure secured to an outer surface thereof to reduce the flexibility of the bellows assembly. A second section may be positioned relative to the first section. The relative positions of the first and second sections may be adjusted to achieve a desired alignment of the first section and the second section. The first section and the second section may be coupled to fixedly retain the desired alignment and the bellows engaging structure subsequently removed from the bellows assembly. In still another aspect, a method of protecting a bellows assembly may include providing a flexible bellows assembly having an outer surface with a first end, a second end and a longitudinal axis. A bellows engaging structure may be positioned adjacent the outer surface of the bellows assembly and about the longitudinal axis of the bellows assembly with an open first end and an open second end of the engaging structure positioned along the longitudinal axis of the bellows assembly. The bellows engaging structure may be secured to the outer surface to restrain the bellows assembly along the longitudinal axis.

### BRIEF DESCRIPTION OF THE DRAWINGS

FIG. 1 is a diagrammatic elevational view of an exhaust gas system for an internal combustion engine with the disclosed engaging structure shown partly in section and positioned over a bellows assembly;

FIG. 2 is a diagrammatic elevation view of the exhaust gas system of FIG. 1 with the engaging structure removed from the bellows assembly;

FIG. 3 is a perspective view of the bellows assembly and engaging structure of FIG. 1;

FIG. 4 is a top plan view of a support sheet of the bellows engaging structure of FIG. 3;

FIG. 5 is a sectional view taken generally along line 5-5 of FIG. 4;

FIG. 6 is a sectional view similar to that of FIG. 5 with the addition of a rubber liner;

FIG. 7 is a sectional view similar to that of FIG. 5 with the addition of a foam liner;

FIG. 8 is a perspective view of an alternate embodiment of the bellows engaging structure;

FIG. 9 is a perspective view of the bellows engaging structure of FIG. 8 positioned on a bellows assembly;

FIG. 10 is a side elevational view of another alternate embodiment of a bellows engaging structure with a bellows assembly positioned therein prior to securing the bellows engaging structure to the bellows assembly;

FIG. 11 is a perspective view of the bellows engaging structure of FIG. 10 positioned around a bellows assembly;

FIG. 12 is a perspective view of another alternate embodiment of a bellows engaging structure positioned on a bellows assembly;

FIG. 13 is an exploded perspective view of an alternate embodiment of a bellows engaging structure; and

FIG. 14 is a perspective view of the bellows engaging structure of FIG. 13 with the bellows engaging structure positioned on a bellows assembly.

### DETAILED DESCRIPTION

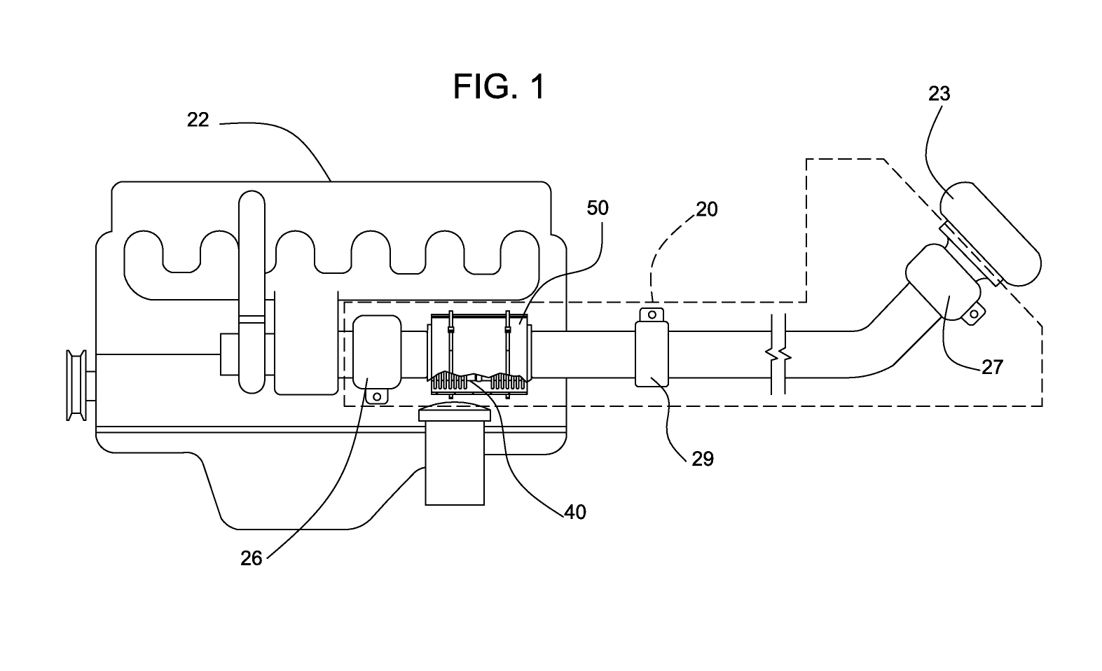

FIG. 1 is a diagrammatic elevational view of a gas handling transport system such as an exhaust gas system 20 for an internal combustion engine 22. The exhaust gas system 20 may be configured to receive exhaust gases from the internal combustion engine 22 and to fluidly communicate the exhaust gases to an exhaust gas receiver 23. The internal combustion engine 22 may be any type of reciprocating internal combustion engines, such as a diesel engine or a gasoline engine, or a non-reciprocating engine, such as a gas turbine engine. The exhaust gas receiver 23 may include, for example, an exhaust discharge stack or an exhaust processing system, such as a catalytic conversion device, or other similar processing systems. The exhaust gas system 20 may be configured to permit positional flexibility of the exhaust gas system during an installation procedure so that suitable clearance may be provided between the exhaust gas system 20 and other components of the internal combustion engine 22 or the exhaust gas receiver 23.

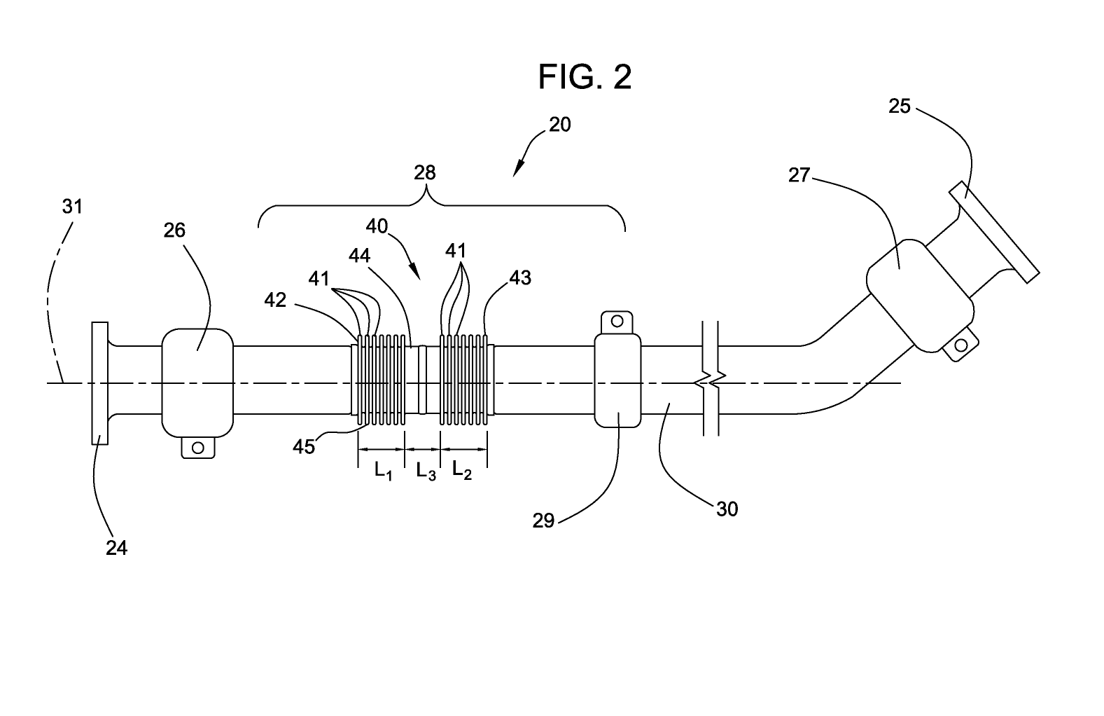

Referring to FIGS. 1-2, the exhaust gas system 20 may include a first flange 24 positioned on one end of the exhaust gas system 20, and a second flange 25 positioned on an opposing end of the exhaust gas system 20. In general terms, the first flange 24 may be configured to adaptably and fluidly couple to an exhaust gas outlet of the internal combustion engine 22, while the second flange 25 may be configured to adaptably and fluidly couple to an inlet of the exhaust gas receiver 23.

The exhaust gas system 20 may also include a first ball joint assembly 26 that is fluidly coupled to the first flange 24, and a second ball joint assembly 27 that is fluidly coupled to the second flange 25. In general, the first ball joint assembly 26 and the second ball joint assembly 27 are configured to permit angular movement so that positional compensation of the exhaust gas system 20 may be achieved.

The exhaust gas system 20 may also include an extensible duct section 28 that is fluidly coupled to the first ball joint assembly 26 and the second ball joint assembly 27. The extensible duct section 28 includes a bellows assembly 40 that is configured to accommodate relative motion between the internal combustion engine 22 and the exhaust gas receiver 23, compensate for thermal expansion and contraction of the exhaust gas system, and provide a vibration dampening function. The bellows assembly 40 includes a plurality of circumferential undulations or convolutions 41 that permit longitudinal movement so that a natural length (e.g., an uninstalled length) of the bellows assembly 40 may contract or expand, while also permitting angular and lateral movement. The extensible duct section 28 may also include a slip joint 29 that is configured to telescopically receive a portion of a transition duct 30. The slip joint 29 may include a circumferential clamp that is configured to fixably and sealably couple the bellows assembly 40 to the transition duct 30.

The transition duct 30 may be suitably configured to direct an exhaust gas flow from the extensible duct section 28 to the exhaust gas receiver 23. Accordingly, the transition duct 30 may include one or more bends so that the exhaust gas flow may be properly routed, and may also include duct sections of different diameters. The first ball joint assembly 26 and the second ball joint assembly 27 are configured to fluidly couple portions of the exhaust gas system 20 to permit the first flange 24 to be angularly deflected, or otherwise angularly positionable relative to the second flange 25. The first ball joint assembly 26 and the second ball joint assembly 27 may also include circumferential clamps to fixedly retain selected angular orientations.

The slip joint 29 may be configured to permit the transition duct 30 to be telescopically received within the bellows assembly 40 so that the transition duct 30 and the bellows assembly 40 may be longitudinally adjusted relative to each other along an axis 31 through bellows assembly 40. The slip joint 29 may also include a circumferential clamp that is configured to fixedly and sealably couple the transition duct 30 to the bellows assembly 40 once the transition duct 30 and bellows assembly 40 are positioned at a desired location.

As depicted in FIG. 2, the bellows assembly 40 may include a first convolution section 42 and a second convolution section 43 that are separated by a straight center section 44 having a length L₃. The first convolution section 42 may have a first natural length L₁ when in a relaxed state, and the second convolution section 43 may have a second natural length L₂ when in a relaxed state. In the various embodiments, the lengths L₁, L₂ and L₃ may be selectively adjusted to achieve one or more structural properties. For example, the lengths L₁, L₂ and L₃ may be selected to achieve a suitable flexural property for the bellows assembly 40. The lengths L₁, L₂ and L₃ may also be selected to provide one or more dynamic properties. For example, the lengths L₁, L₂ and L₃ may also be selected to provide a suitable resonant frequency for the bellows assembly 40. In addition, the bellows assembly 40 may be modified by eliminating one of the first convolution section 42, the second convolution section 43 or the straight center section 44. If the straight center section 44 is eliminated, the first convolution section 42 and the second convolution section 43 will form a continuous convolution length extending along bellows assembly 40.

Although the various disclosed embodiments are directed to exhaust gas systems and methods, the disclosed embodiments may also be applied to other gas handling systems. For example, the various embodiments may be applied to an air induction system, or to an exhaust gas recirculation system and any other gas or fluid handling systems utilizing a bellows assembly.

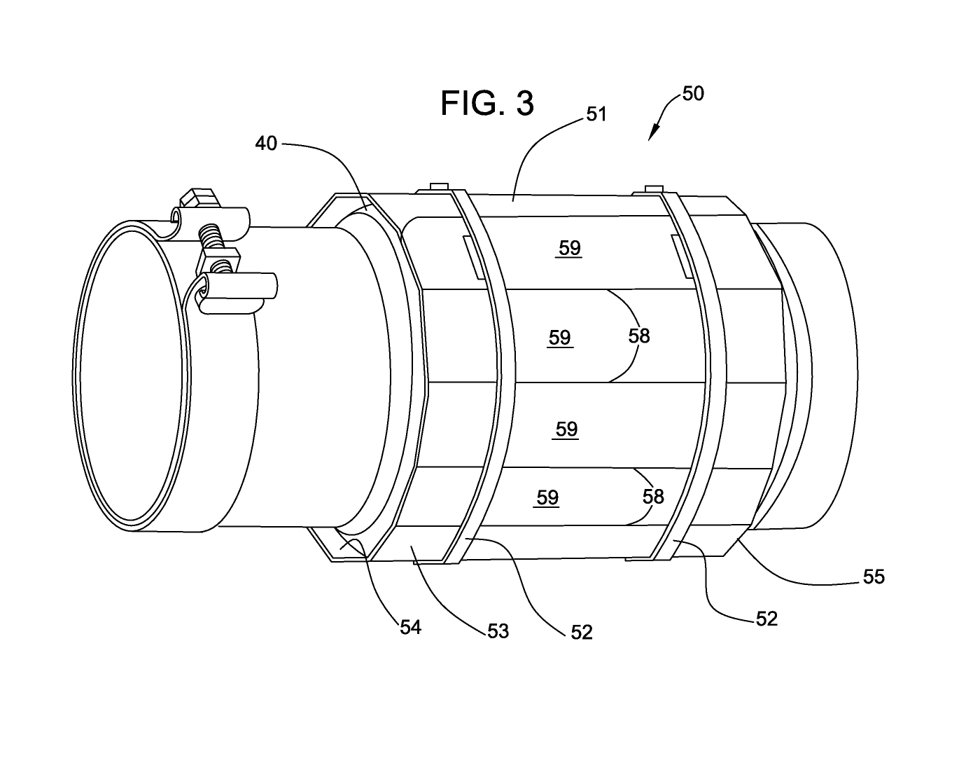

The bellows assembly 40 may be secured in a desired position during the process of assembling the exhaust gas system 20 by fixing to the bellows assembly to a structure that will provide support and protection and reduce or constrain flexibility or movement. This structure may also protect the bellows assembly during transportation to the installation site and during the process of assembling the exhaust gas system. FIGS. 1, 3 depict an engaging structure 50 for supporting and protecting the bellows assembly 40 during assembly of the exhaust gas system 20 and to protect the bellows assembly during transportation. The engaging structure includes a flexible, continuous support sheet 51 wrapped around and engaged with a portion of the generally cylindrical outer surface 45 of bellows assembly 40. More specifically, the support sheet 51 engages the outer surfaces of the first convolution section 42 and the second convolution section 43 of the bellows assembly 40. The support sheet 51 may be circumferentially retained around the bellows assembly 40 through the use of a securing device. Various structures may be used including one or more retention or securing members 52 (e.g., cable ties) that encircle and engage the outer surface 53 of support sheet 51. In an alternate embodiment, an adhesive (not shown) such a tape or glue may be applied along the seam of the support sheet 51.

Engaging structure 50 has an open first end 54 and an open second end 55, opposite the open first end. A portion of the bellows assembly 40 extends from each of the open first end 54 and the open second end 55 which permits the bellows assembly 40 to be assembled as part of the exhaust gas system 20 while longitudinal, lateral and rotational movement of the bellows assembly is eliminated or reduced due to the engaging structure 50 that is secured thereto. In the alternative, if a portion of the bellows assembly does not extend from each of the open first end 54 and the open second end 55, the bellows assembly 40 may still be secured and the exhaust gas system 20 assembled but the final interconnection between the bellows assembly 40 and the exhaust gas system could not be completed until after removal of the engaging structure.

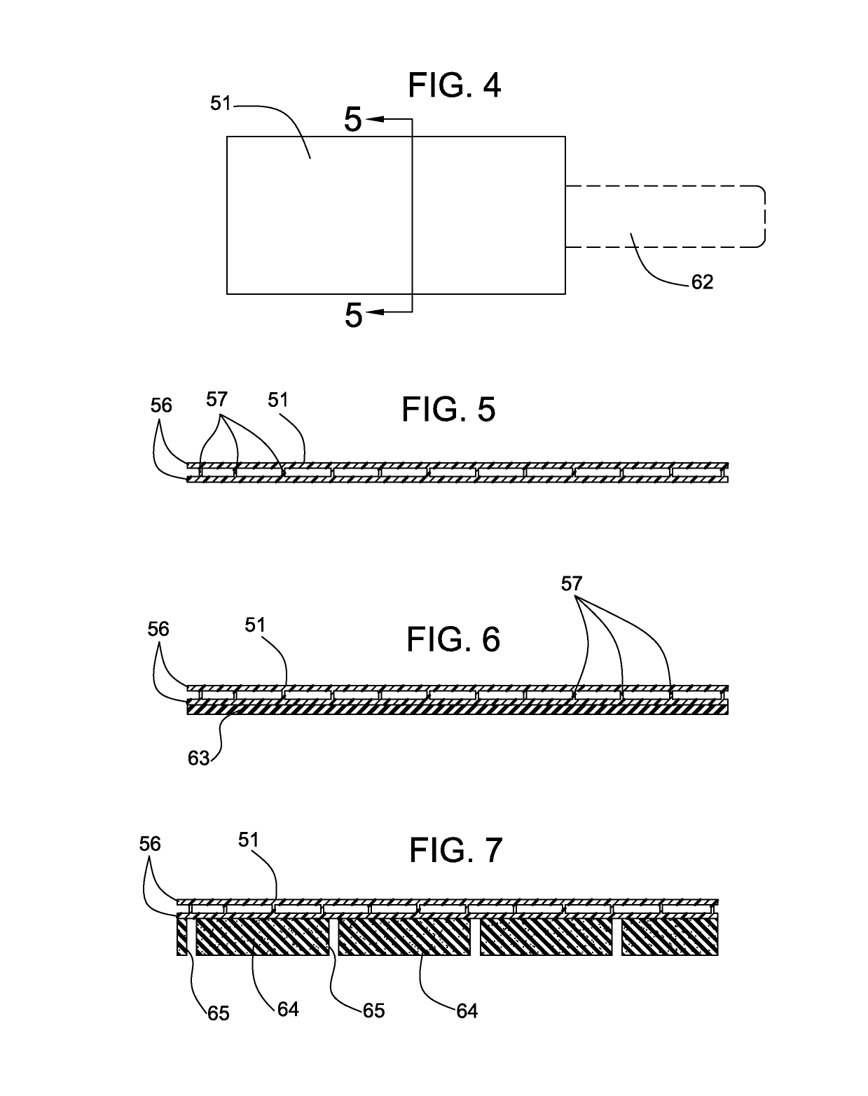

Referring to FIGS. 4-5 support sheet 51 may be formed of a material that is sufficiently flexible so as to be wrapped around the bellows assembly 40 yet provide sufficient rigidity to reduce the likelihood of significant movement of the bellows assembly. In one embodiment, corrugated plastic sheet material such as polyproplene has proven to be effective. The corrugated sheet material has a pair of spaced apart outer layers 56 with a series of flutes or corrugations 57 between the outer layers. By positioning the corrugated sheet material with the corrugations 57 generally parallel to the longitudinal axis 31 of the bellows assembly 40, the support sheet 51 is relatively flexible in a direction that will permit wrapping the support sheet around the bellows assembly yet the corrugations provide a relatively stiff structure to support the bellows assembly and resist movement thereof. Other corrugated materials such as fiberboard may also be used as well as single-ply sheets of various other materials including sheet metal. The support sheet 51 may be formed with a series of bends or creases 58 that serve as lines about which the support sheet 51 may be bent so as to ease the process of wrapping the support sheet around the bellows assembly 40 and form a series of spaced apart panels or facets 59. In an alternate embodiment without pre-formed bends or creases, the support sheet 51 will tend to bend about the corrugations 57 of the support sheet during the wrapping process to also form the facets 59. In use, the support sheet 51 is wrapped around the bellows assembly 40 and the securing members 52 wrapped around the support sheet and tightened around the first convolution section 42 and the second convolution section 43 of the bellows assembly until the engaging structure 50 is firmly secured to the bellows assembly. Aligning the corrugations 57 of the support sheet parallel to the axis 31 of bellows assembly 40 will increase the rigidity of the bellows assembly and resistance to lateral movement. Securing the support sheet 51 to the bellows assembly 40 will also increase the resistance to longitudinal and rotational movement of the bellows assembly.

Referring to FIG. 4, a tongue or section 62 of reduced width may extend from support sheet 51 for alignment with and positioning around straight center section 44 of bellows assembly 40. Referring to FIG. 6, a resilient liner 63 may be applied to the inner surface of the support sheet to more securely fix the support sheet to the bellows assembly 40. In some embodiments, the resilient liner 63 has been found to increase the rigidity of the bellows assembly 40 when restrained by the engaging structure 50. In one embodiment, the liner may be an elastomeric material such as rubber so as that the support sheet includes a first relatively stiff outer layer (e.g., formed of a plastic sheet material) and a resilient inner layer (e.g., formed of rubber). In another embodiment depicted in FIG. 7, the resilient liner may be a foam material 64. If desired, air gaps or voids 65 may be included in the liner to facilitate wrapping the support sheet 51 and resilient liner 63 around the bellows assembly 40.

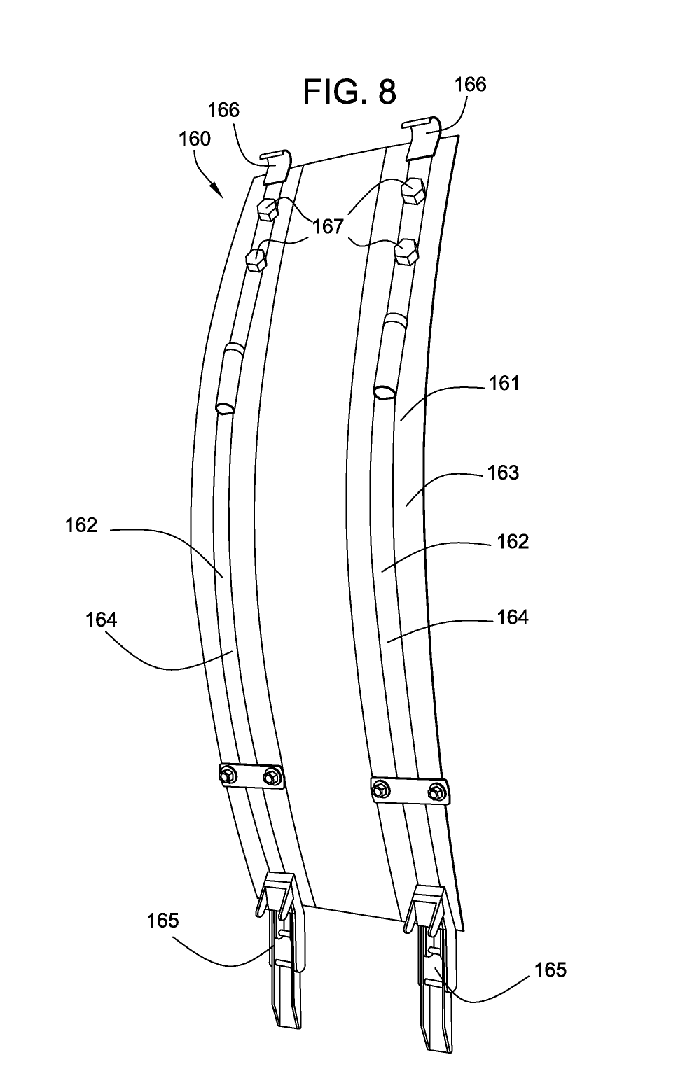

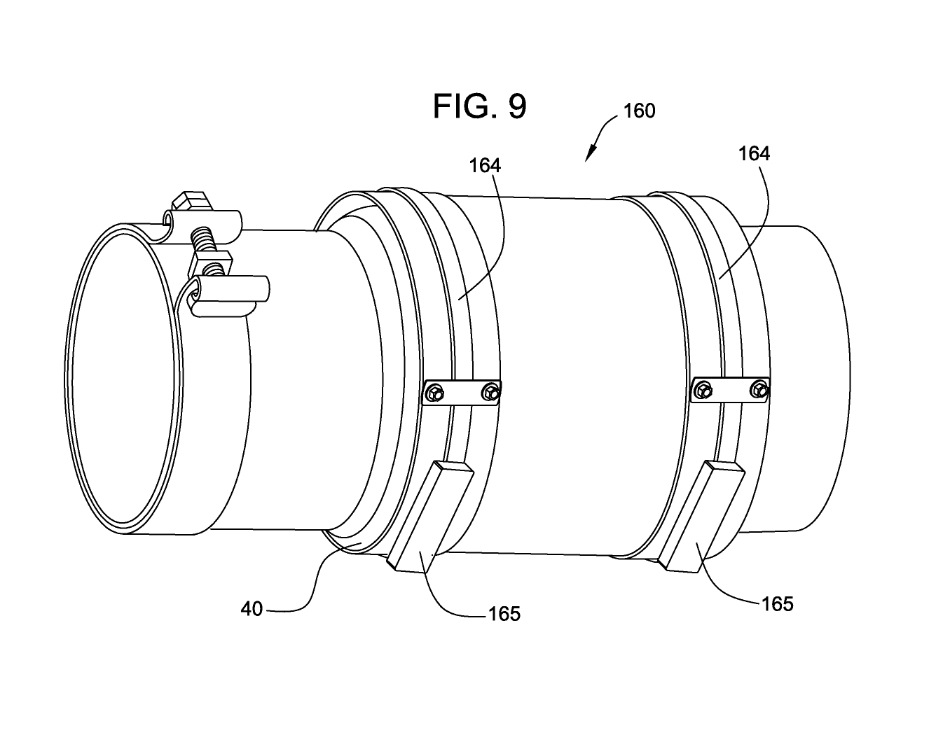

In an alternate embodiment depicted in FIGS. 8-9, engaging structure 160 includes a support sheet 161 formed of sheet metal. As with the support sheet 51 depicted with respect to FIGS. 3-7, the support sheet 161 is sufficiently flexible so as to be capable of being wrapped around and engaging the bellows assembly 40 yet provide sufficient rigidity to reduce the likelihood of significant movement of the bellows assembly. Support sheet 161 may be retained on and encircle the bellows assembly 40 through the use of one or more retention or securing members 162 that encircle and engage the outer surface 163 of support sheet 161. The securing members 162 may include straps 164 with a latching element 165, 166 at the ends of each strap. In an alternate embodiment (not shown), a single latching element may be used that directly engages strap 164. If desired, the straps 164 may be permanently mounted to one end of the support sheet 161 by retention members 167. In use, the support sheet 161 is wrapped around the bellows assembly 40 and the securing members 162 tightened around the first convolution section 42 and the second convolution section 43 of the bellows assembly until the engaging structure 160 is firmly secured to the bellows assembly.

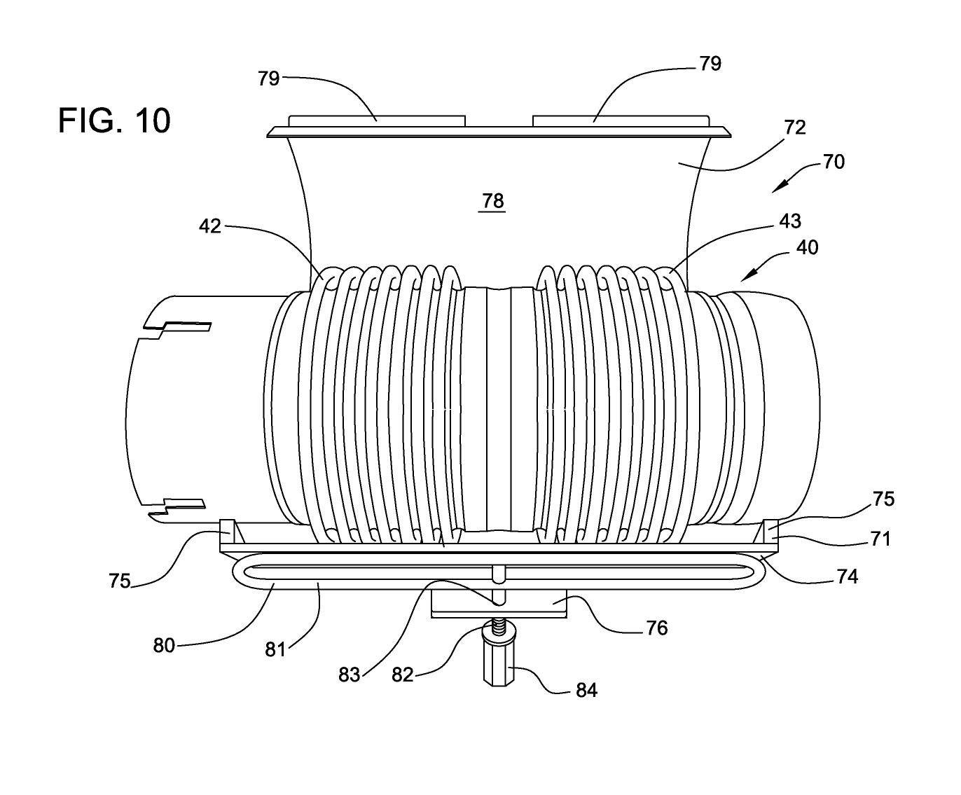

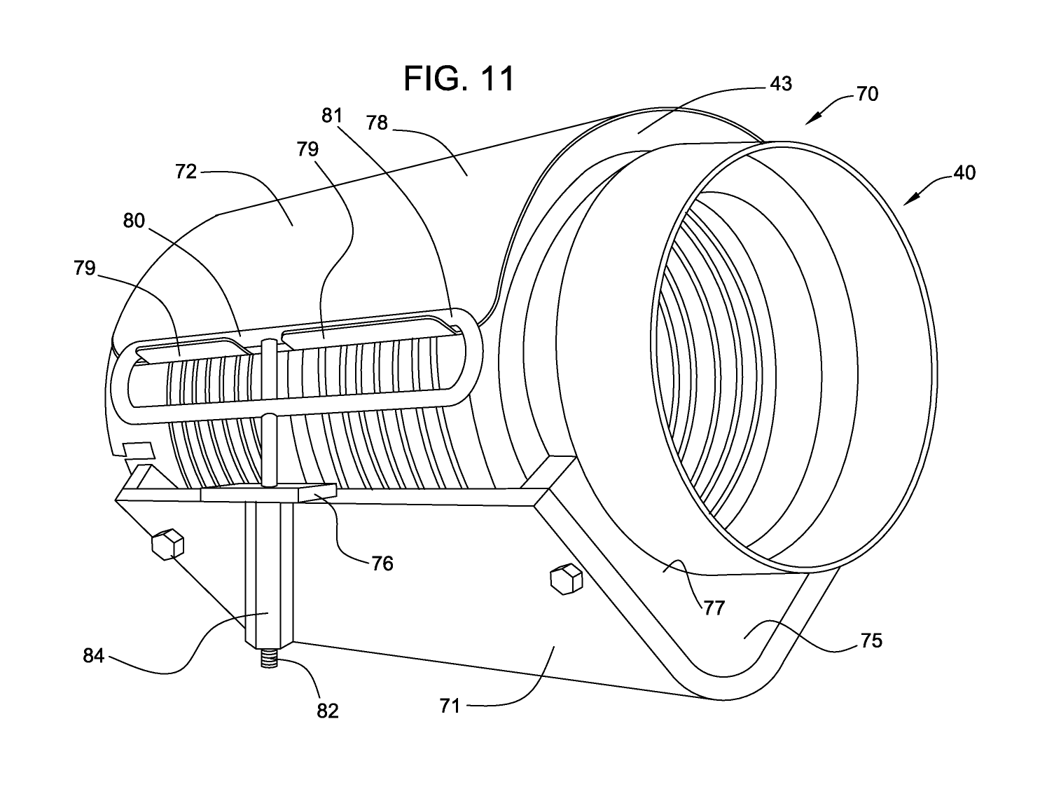

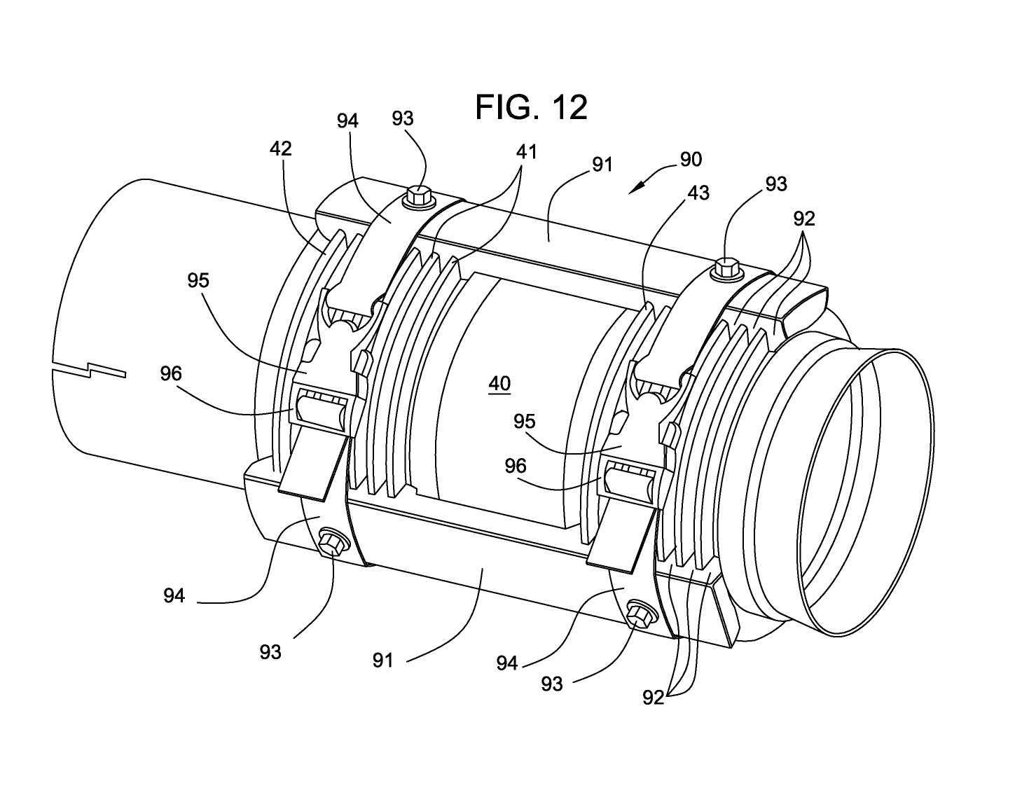

In another alternate embodiment depicted in FIGS. 10-11, engaging structure 70 includes a first support member 71 and a second support member 72 rotatably connected to the first support member by a hinge (not shown). First support member has a curved sheet metal body 74 with a generally triangular flange 75 at each end to provide additional rigidity to the sheet metal body 74 and a central latching flange 76 generally centrally located along one edge of the first support member opposite the hinge. The sheet metal body may be configured to engage the outer surface of the first convolution section 42 and the second convolution section 43 of bellows assembly 40 The generally triangular flanges 75 are spaced apart so as to be positioned on opposite sides or outboard of the first convolution section 42 and the second convolution section 43 and they may be configured to engage the bellows assembly 40 at such location by including an arc-shaped inner surface 77. Second support member 72 has a curved sheet metal body 78 for engaging the outer surface of the first convolution section 42 and the second convolution section 43 of the bellows assembly 40 and an elongated latching flange 79 along one edge of the second support member opposite the hinge. A securing device 80 includes an oval-shaped body 81 with one or more threaded locking bolts extending therefrom. In order to secure a bellows assembly 40 within the engaging structure 70, the first support member 71 and the second support member 72 are positioned around the bellows assembly 40 with the central latching flange 76 of the first support member 71 adjacent the elongated latching flange 79 of the second support member 72. The oval-shaped body 81 of the securing device 80 is positioned along the elongated latching flange 79 with the locking bolt 82 extending through a hole 83 in central locking flange 76 of first support member 71. A threaded fastener such as a nut 84 is threaded onto locking bolt 82 and tightened so that the first support member 71 and the second support member 72 move together to secure first support member 71 to second support member 72 with the bellows assembly 40 fixed therebetween.

FIG. 12 depicts another alternate embodiment of an engaging structure 90 for supporting and fixing the bellows assembly 40 during the process of assembling the exhaust gas system 20. Engaging structure 90 includes a plurality of rigid, elongated convolution engaging members 91 that are spaced apart circumferentially around the bellows assembly 40. Each convolution engaging member 91 has a plurality of internally extending (when mounted on bellows assembly 40) projections 92 for engaging the convolutions 41 of bellows assembly 40. The projections 92 are configured to be positioned between and engage the convolutions 41 of each of the first convolution section 42 and the second convolution section 43 of the bellows assembly 40. The convolution engaging members 91 may be formed of a molded material such as plastic or some other relatively rigid material. The convolution engaging members 91 are secured by fasteners 93 to a pair of securing members in the form of one or more flexible straps 94. Intermatable first latching member 95 and second latching member 96 may be secured to each end of the flexible straps 94 to facilitate positioning the engaging structure 90 around the bellows assembly 40. In use, the convolution engaging members 91 are connected to each of the flexible straps 94 and are positioned around the outer surface of the bellows assembly 40 with the projections 92 positioned between the convolutions 41. The first latching member 95 and second latching member 96 at the end of each flexible strap 94 are latched together and the straps tightened to secure the convolution engaging members 91 around the first convolution section 42 and the second convolution section 43 of the bellows assembly so that the engaging structure 90 is firmly secured to the bellows assembly.

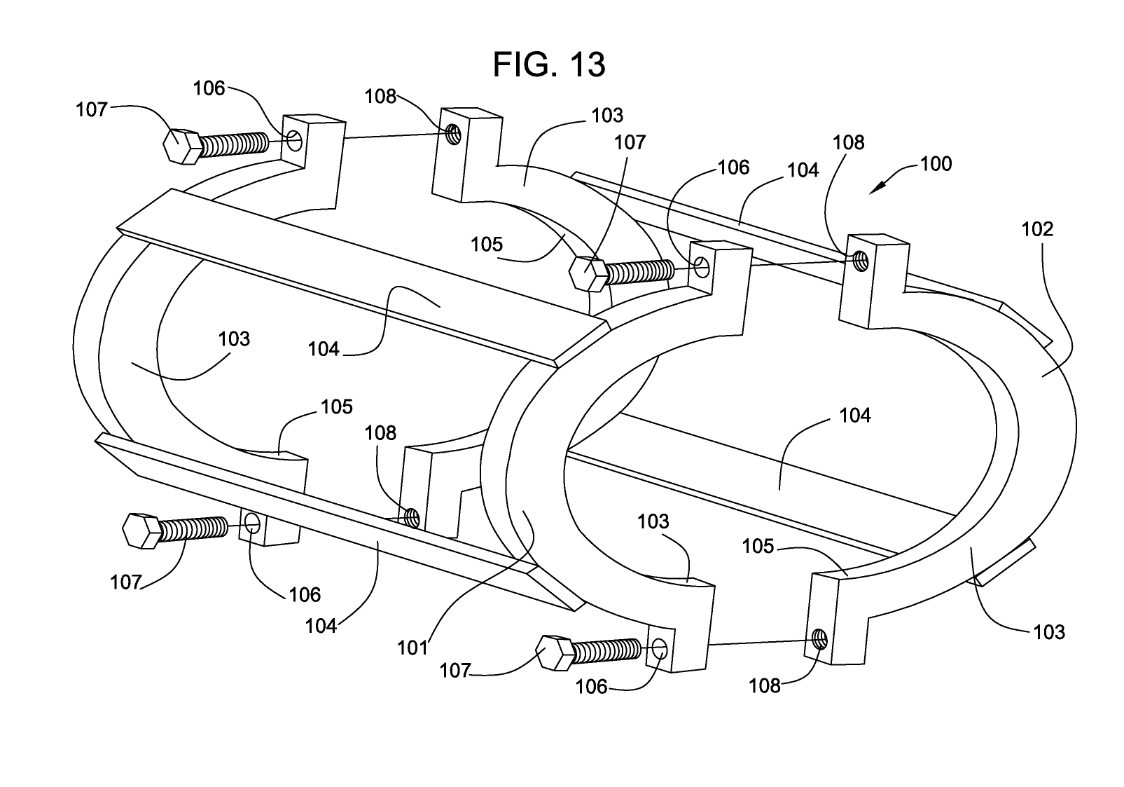

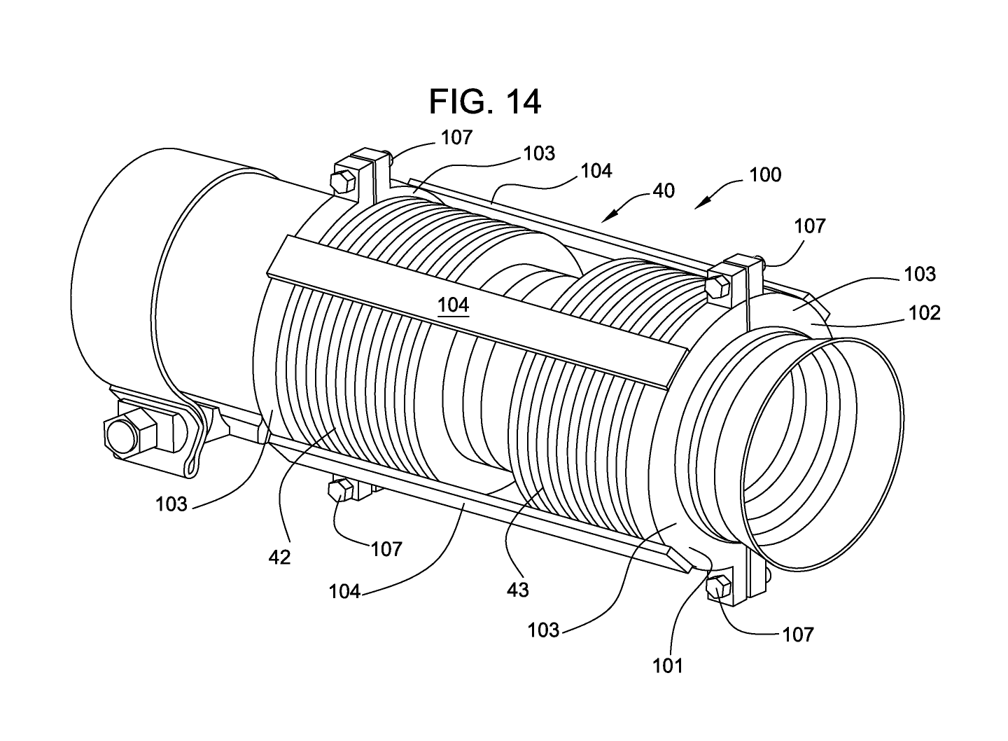

FIGS. 13-14 depict another alternate embodiment of an engaging structure 100 for supporting and fixing the bellows assembly 40 during the process of assembling the exhaust gas system 20. Engaging structure 100 includes generally identical first and second support members 101, 102. Each support member 101, 102 has a pair of arc-shaped flanges 103 at opposite ends interconnected by a pair of elongated web members 104. The radius of inner surface 105 of arc-shaped flanges 103 may be configured so as to engage the bellows assembly 40 on opposite sides or outboard of the first convolution section 42 and the second convolution section 43 to fix the bellows assembly in place. Each arc-shaped flange 103 has a hole at opposite ends thereof. The holes 106 of first support member 101 are dimensioned so as to permit a bolt 107 to pass therethrough. The holes 108 of second support member 102 are threaded and dimensioned so as to permit a bolt 107 to be secured therein. In use, the first support member 101 and the second support member 102 are positioned around the bellows assembly 40. A bolt 107 is slid through each hole 106 in first support member 103 and into the hole 108 in second support member 102. The bolts 107 are tightened so that the first and second support members 101, 102 engage the bellows assembly 40 around the circumference outboard of the first convolution section 42 and the second convolution section 43. The support members 101 and 102 are configured with a gap between the web members 104 and the first convolution section 42 and the second convolution section 43 so that the web members 104 do not touch the outer surface of the bellows assembly 40. The first and second support members 101, 102 may be formed of metal or some other relatively rigid material.

### INDUSTRIAL APPLICABILITY

The industrial applicability of the system described herein will be readily appreciated from the foregoing discussion. The present disclosure is applicable to systems that include bellows assemblies, such as gas handling systems. When configuring a gas handling system, the dimensions and characteristics of a bellows assembly within the system are typically selected based upon certain desired performance characteristics. However, because gas handling systems such as an exhaust gas system may include multiple components such as ball joint assemblies and slip joint assemblies that permit significant movement of one end of the exhaust gas system relative to the other end during assembly, proper positioning of the ends of the exhaust gas system may be achieved to some extent by undesirably deflecting the bellows assembly during the assembly process. In other words, due to the flexible nature of a bellows assembly, rather than achieving the desired alignment of the components of the exhaust gas system during assembly by rotating and/or sliding the various components, the bellows assembly may be flexed in order to properly position the ends of the exhaust gas system. Such flexing of the bellows assembly may negatively impact the desired performance of the bellows assembly within the exhaust gas system.

The disclosed system operates to support and protect a bellows assembly during assembly of a gas handling system and further operates to protect the bellows assembly during transportation prior to assembly of the gas handling system. In one embodiment, a structure for restraining or engaging a bellows assembly includes an engaging surface that engages a portion of an outer surface of the bellows assembly. The structure may have an open first end and an open second end along the longitudinal axis of the bellows assembly to permit assembly of the gas handling system while the engaging structure is fixed to the bellows assembly. A securing device may be provided for removably securing the engaging structure to the bellows assembly.

In one embodiment, a gas handling system including a bellows assembly may be assembled by engaging the bellows assembly and subsequently assembling the gas handling system. The gas handling system may include a first section including a flexible bellows assembly with a bellows engaging structure secured to an outer surface thereof to reduce movement of the bellows assembly. A second section may be positioned relative to the first section and relative positions of the first and second sections adjusted to achieve a desired alignment of the first section and the second section. The first and second sections may then be coupled to fixedly retain the desired alignment and the bellows engaging structure removed from the bellows assembly to remove the constraints on the flexibility of the bellows assembly. The bellows engaging structure may be removed from the bellows assembly by removing straps that secure the bellows engaging structure to the bellows assembly. The first section may be coupled to a first system component and the second section coupled to a second system component prior to the removing the bellows engaging structure from the bellows assembly. The first section, the second section, the first system component and the second system component may all be loosely connected prior to the coupling the first section and the second section.

In one embodiment, a bellows assembly may be protected by securing to the bellows assembly a bellows engaging structure having open ends aligned with ends of the bellows assembly. The bellows engaging structure may be positioned adjacent an outer surface of the bellows assembly and about a longitudinal axis of the bellows assembly with an open first end and an open second end of the engaging structure being positioned along the longitudinal axis of the bellows assembly. The bellows engaging structure may be secured to the outer surface to restrain the bellows assembly along the longitudinal axis. The bellows assembly may be transported and assembled as part of a gas handling system with the engaging structure in place to protect the bellows assembly.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A gas handling transport assembly comprising:
a flexible bellows assembly having an outer surface with a first end, a second end and a longitudinal axis, and a plurality of convolutions positioned between the first end and the second end along the longitudinal axis;
a bellows engaging structure having an engaging surface configured to engage a portion of the outer surface of the bellows assembly, the bellows engaging structure having an open first end and an open second end along the longitudinal axis of the bellows assembly; and
a securing device for removably securing the bellows engaging structure to the bellows assembly.

2. The assembly of claim 1, wherein the engaging surface of the bellows engaging structure generally encircles the outer surface of the bellows assembly.

3. The assembly of claim 1, wherein the engaging surface of the bellows engaging structure engages the outer surface of the bellows assembly generally adjacent the first end and the second end of the bellows assembly.

4. The assembly of claim 1, wherein the securing device includes a pair of spaced apart securing members for securing the bellows engaging structure to the bellows assembly.

5. The assembly of claim 4, wherein the securing members are positioned generally adjacent the open first end and the open second end of the bellows engaging structure.

6. The assembly of claim 1, wherein the bellows assembly includes a first convolution section and a second convolution section spaced from the first convolution section, and the securing device is positioned between the first convolution section and the second convolution section.

7. The assembly of claim 1, wherein the bellows engaging structure includes a flexible support sheet including the engaging surface.

8. The assembly of claim 7, wherein the flexible support sheet extends around the bellows assembly in a generally continuous manner.

9. The assembly of claim 7, wherein the flexible support sheet is formed of a corrugated plastic material.

10. The assembly of claim 7, wherein the flexible support sheet includes a first relatively stiff outer layer and a resilient inner layer, the inner layer engaging the outer surface of the bellows assembly.

11. The assembly of claim 10, wherein the inner layer is formed of an elastomeric material.

12. The assembly of claim 7, wherein the flexible support sheet is formed of a corrugated fiberboard material.

13. The assembly of claim 1, wherein the bellows engaging structure includes at least two rigid components that define the engaging surface.

14. A method of assembling a gas handling transport system, comprising:
providing a first section including a flexible bellows assembly with a bellows engaging structure secured to an outer surface thereof to reduce movement of the bellows assembly;
positioning a second section relative to the first section;
adjusting the relative positions of the first section and the second section to achieve a desired alignment of the first section and the second section;
coupling the first section and the second section to fixedly retain the desired alignment; and
removing the bellows engaging structure from the bellows assembly.

15. The method of claim 14, wherein the removing step includes removing straps securing the bellows engaging structure to the bellows assembly.

16. The method of claim 14, further including the steps of coupling the first section to a first system component and coupling the second section to a second system component prior to the removing step.

17. The method of claim 16, wherein the first section, the second section, the first system component and the second system component are all loosely connected prior to the coupling step.

18. A method of protecting a bellows assembly, comprising:
providing a flexible bellows assembly having an outer surface with a first end, a second end and a longitudinal axis;
positioning a bellows engaging structure adjacent the outer surface of the bellows assembly and about the longitudinal axis of the bellows assembly with an open first end and an open second end of the engaging structure being positioned along the longitudinal axis of the bellows assembly; and
securing the bellows engaging structure to the outer surface to restrain the bellows assembly along the longitudinal axis.

19. The method of claim 18, wherein the positioning step includes wrapping a support sheet generally around the bellows assembly.

20. The method of claim 19, wherein the securing step further includes generally encircling the bellows assembly with at least one securing member.
